(19) United States
(12) Patent Application Publication
(10) Pub. No.: US 2013/0135199 A1
(43) Pub. Date: May 30, 2013

(54) SYSTEM AND METHOD FOR USER INTERACTION WITH PROJECTED CONTENT

(71) Applicants: Haim Perski, Hod-HaSharon (IL); Gil Wohlstadter, Givatayim (IL); Ovadya Menadeva, Modiin (IL); Eran Eilat, Givatayim (IL)

(72) Inventors: Haim Perski, Hod-HaSharon (IL); Gil Wohlstadter, Givatayim (IL); Ovadya Menadeva, Modiin (IL); Eran Eilat, Givatayim (IL)

(73) Assignee: Pointgrab Ltd

(21) Appl. No.: 13/814,756

(22) PCT Filed: Aug. 10, 2011
(86) PCT No.: PCT/IL11/00651

§ 371 Date: Feb. 7, 2013

Related U.S. Application Data
(60) Provisional application No. 61/372,141, filed on Aug. 10, 2010.
(60) Provisional application No. 61/372,124, filed on Aug. 10, 2010.

(51) Int. Cl. G06F 3/01

(52) U.S. Cl. CPC G06F 3/017
USPC 345/156

(57) ABSTRACT

A system and method for user interaction with projected content are provided. A computer generated image is projected onto a surface, the computer generated image comprising at least one symbol. The projected computer generated image is imaged to obtain a sensor image. The location of the symbol within the sensor image is detected and based on the location of the symbol in the sensor image a device may be controlled.

### FIELD OF THE INVENTION

The present invention relates to the field of computer vision based control of devices, specifically in systems for displaying/projecting content.

### BACKGROUND OF THE INVENTION

It has become common to display data or content to an audience by projecting computer generated content onto a wall or screen, for example, during lectures, slide shows, movies, etc. In a presentation lecture, for example, the lecturer typically controls his presentation through the user interface of the computer. Often, when the lecturer wishes to point or highlight something on the screen, he uses a pointer or he physically walks up to the screen to point directly at the screen. He then must walk back to the computer to move slides or otherwise control his presentation. Alternatively, someone else from the audience may control the presentation for him.

Interactive display systems are known, such as an interactive whiteboard, in which a special display, which is essentially a touch screen, is connected to a computer and projector. The projector projects the computer's desktop onto the display's surface where users control the computer using a pen, finger or other device by touching the display. This system requires a dedicated touch sensitive display device which may be expensive and impractical for most presenters.

To date there is no system which enables simple and affordable control of displayed content, such as a presentation, by interacting with the displayed content.

### SUMMARY OF THE INVENTION

The system and method according to embodiments of the invention enable to calculate the distance of a user's hand from a surface on which content is being projected, such as a wall, screen etc. Using the calculated distance of the user's hand from the wall or screen, hand movement may be translated into a specific interaction with the projection surface, essentially turning the projection surface into a virtual touch screen.

In one aspect of the invention there is provided a system for user interaction with projected content, the system comprising a device to produce a computer generated image, said image comprising at least one symbol; a projecting device in communication with said device, the projecting device to project said computer generated image at least onto a surface; an image sensor to capture an image of the projected computer generated image, thereby obtaining a sensor image of the symbol, wherein the image sensor line of sight to said surface is different than the projecting device line of sight to said surface; and a processing unit to detect a location of the at least one symbol in the sensor image, and based on the location of the symbol in the sensor image, operate an application of the device.

In another aspect the projecting device is to project the computer generated image onto a user hand and the processing unit is to calculate a distance of the user's hand from the surface based on the location of the symbol in the sensor image of symbol.

In another aspect the system includes a processor for transforming coordinates of the sensor image to coordinates of the computer generated image.

In another aspect there is included a processor to: calculate an expected location of the at least one symbol in the sensor image; detect an actual location of the at least one symbol in the sensor image; and compare the expected location to the actual location.

In yet another aspect there is provided a processor to: identify a hand in the sensor image; identify the hand location within the sensor image; translate the hand location within the sensor image to a hand location within the computer generated image; and generate the computer generated image comprising at least one symbol located at the hand location within the computer generated image.

In one aspect the image sensor is in a fixed position relative to the projecting device.

In one aspect of the invention there is provided a processor to determine if the distance of the user's hand from the surface is below a pre-determined distance and if the distance of the user's hand from the surface is below a pre-determined distance, to operate an application of the device.

In some aspects the processor is to simulate a touch event on the computer generated image, at the location of the hand.

In some aspects the processor is to generate the computer generated image comprising a symbol located at an extrapolated location. The extrapolated location may be calculated based on the location of the user hand within the sensor image and/or on the movement of the user's hand.

In another aspect of the invention a method for user interaction with projected content, is provided. The method, according to some aspects, includes the steps of: projecting a computer generated image onto a surface, said computer generated image comprising at least one symbol; imaging the projected computer generated image to obtain a sensor image; detecting the location of the symbol within the sensor image; and based on the location of the symbol in the sensor image, operating an application of the device.

In some aspects the method includes projecting the computer generated image onto a user hand and calculating a distance of the user hand from the surface based on the location of the symbol in the sensor image.

In other aspects the method includes transforming coordinates of the sensor image to coordinates of the computer generated image.

In some aspects the method includes detecting a location of the user hand within the sensor image.

In other aspects the method includes determining if the distance of the user's hand from the surface is below a pre-determined distance and if the distance of the user's hand from the surface is below a pre-determined distance, simulating a touch event on the computer generated image at the location of the hand.

In some aspects calculating a distance of the user hand from the surface comprises: calculating an expected location of the symbol in the sensor image; detecting an actual location of the symbol in the sensor image; and comparing the expected location to the actual location.

In another aspect of the invention the method includes: identifying a hand in the sensor image; identifying the hand location within the sensor image; translating the hand location within the sensor image to a hand location within the computer generated image; and generating the computer generated image comprising at least one symbol located at the hand location within the computer generated image.

In some aspects the method includes extrapolating the location of the symbol within the computer generated image based on the location and/or movement of the user hand within the sensor image.

In another aspect of the invention there is provided a method for detecting an external object on projected computer generated content, the method comprising: creating a color transformation function between a projected computer generated image and a sensor image of the projected computer generated image; transforming coordinates of the projected computer generated image to coordinates of the sensor image; transforming color space of the projected computer generated image to the color space of the sensor image, thereby obtaining a transformed image; comparing the transformed image to the sensor image; and determining if an external object is detected in the sensor image based on the comparison.

In some aspects the method includes: projecting a color calibration computer generated image; imaging the projected color calibration image thereby obtaining a calibration sensor image; and creating a color map based on the calibration sensor image and computer generated image, and using the color map as the color transformation function.

In some aspects transforming coordinates of the computer generated image to coordinates of the sensor image comprises transforming corners of the computer generated image to corners of coordinates of the sensor image.

In some aspects of the invention the external object is a user hand.

### BRIEF DESCRIPTION OF THE FIGURES

The invention will now be described in relation to certain examples and embodiments with reference to the following illustrative figures so that it may be more fully understood. In the drawings:

FIGS. 1A and 1B schematically illustrate an exemplary system according to two embodiments of the invention;

FIGS. 2A and 2B depict flow charts which schematically illustrate methods of interacting with projected content, according to two embodiments of the invention;

FIG. 3 depicts a flow chart schematically illustrating a method for calculating distance of a user's hand from a projection surface, according to an embodiment of the invention;

FIG. 4 schematically illustrates an exemplary method for detecting a user hand within a sensor image, according to an embodiment of the invention; and

FIG. 5 schematically illustrates an exemplary method of translating displacement of a symbol in a sensor image into distance of a user hand from a surface, according to one embodiment of the invention.

### DETAILED DESCRIPTION OF THE INVENTION

The system and method according to embodiments of the invention enable interaction with projected, displayed content.

The system and method according to embodiments of the invention enable to calculate the distance of a user hand from a surface on which content is being projected (projection surface), such as a wall, screen etc. Using the calculated distance of a user's hand from the projection surface, hand movement may be translated into a specific interaction with the projection surface, essentially turning the projection surface into a virtual touch screen.

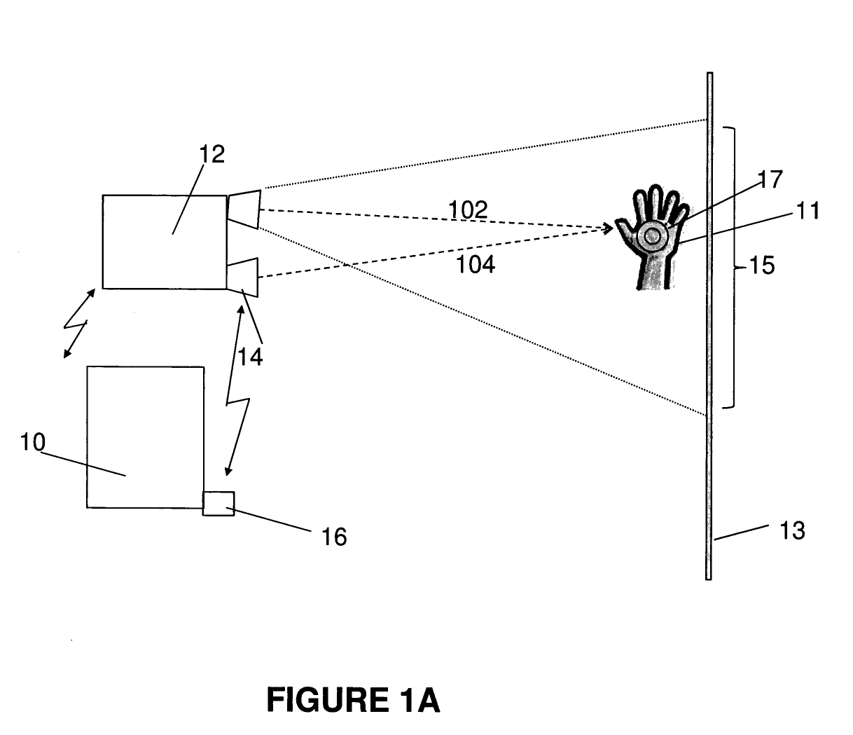

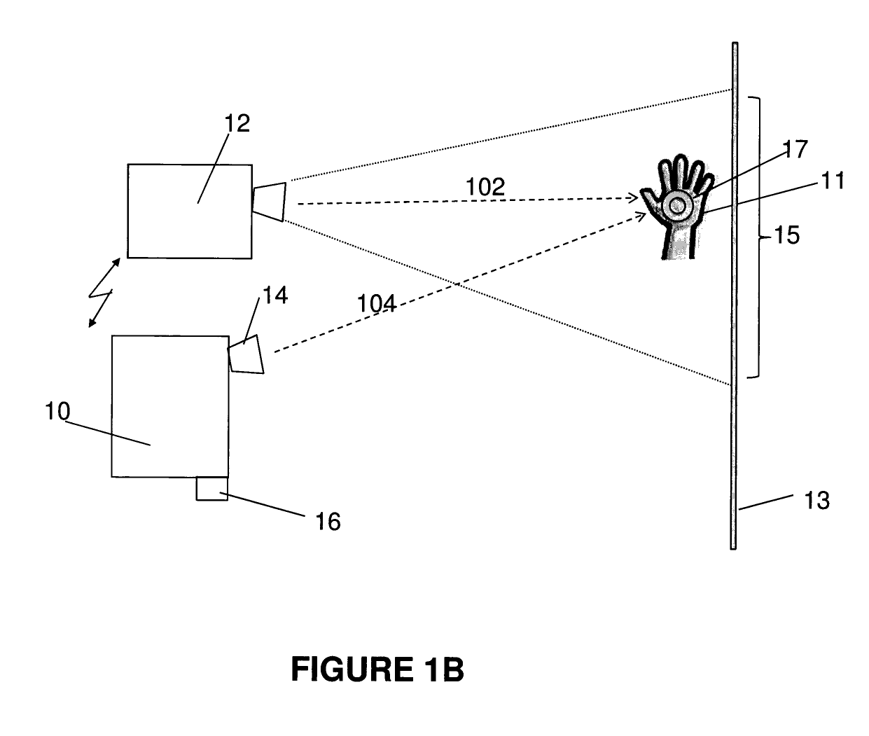

An exemplary system according to two embodiments is schematically illustrated with reference to FIGS. 1A and 1B. The system includes a device 10 for producing a graphical image and a projecting device 12, which is in communication with device 10, to project the graphical image on a projection surface, such as surface 13. The graphical image, which is typically a computer generated image, is projected onto surface 13 in a projection area 15.

A projecting device 12, according to one embodiment of the invention, includes a light source; a means to create images in the form of emitted light (such as cathode ray tubes, LCD light gates, digital micro-mirror devices etc.) and an optical system for focusing a projected image on a projection surface. Typically, surface 13 is a surface diffusely reflecting the light projected on to it.

Device 10, which may be, for example, a PC, and projecting device 12 may be connected by an appropriate wired connection, such as by a VGA connector or HDMI interface. Alternatively, device 10 and projecting device 12 may communicate wirelessly, such as by IR, Bluetooth etc.

Also included in the system is an image sensor 14 for capturing an image of the projection area 15.

Image sensor 14 may include any suitable sensor, such as a CCD or CMOS operative, for example, in the visible and IR range. Image sensor 14 may be a 2D camera typically available in many platforms such as in mobile PCs, mobile phones, etc.

The projecting device 12 may project content typically produced by device 10, such as a presentation, a document, a slide show, pictures, a movie or any other desired content. Device 10 also produces a symbol 17, such as a ring, which is projected by projecting device 12. Other symbols may be produced and projected, such as a cross, dot, line, “X” or any other desired symbol.

According to one embodiment of the invention symbol 17 is projected onto surface 13 and imaged by image processor 14. An external object (such as a user hand or a user held object) being placed upon the surface, within the projection area 15, at the location of the projected symbol, will cause the symbol to be displaced in the image of the projection area, from its original location, prior to when the external object came into view of the image sensor.

A processor 16, which is in communication with device 10 and with image sensor 14, can detect the location of the symbol 17 in the image captured by image sensor 14 and based on the location of the symbol, processor 16 may control the device, for example by operating a command or an application of the device 10. For example, a symbol may be generated (e.g., by processor 16) such that it is projected onto a specific part of a presentation (or other projected content), such as onto a computer generated button or icon. A user might use his hand to press or touch the surface at the location of the computer generated button or icon. The insertion of the user hand into the projection area at the location of the button or icon will cause displacement of the symbol in an image of the projection area.

According to one embodiment the processor 16 (or another processor) may also be capable of identifying a user hand 11 in the image captured by image sensor 14 and may calculate the distance of the user hand 11 from the surface 13, typically based on the displacement of the symbol being projected onto the hand. Movement of the hand (e.g., closer to the surface) may control the device 10, for example, may cause a certain application of device 10 to be operated (e.g., a Windows applications may be run or a command within an application may be executed).

Thus, a user may interactively use the projection area 15 by bringing his hand 11 into the projection area 15 and pointing, pressing or otherwise interacting with elements of the graphical display being displayed in projection area 15. For example, once a lecturer's laptop is connected to a projector, the desktop of the laptop is projected onto a screen. The lecturer may open a file on his desktop and select his presentation from the file by bringing his hand in proximity to the screen and tapping on the icon of the file which is displayed on the screen. The lecturer's hand should be within view of an image sensor which is possibly fixed or attached onto the projector, or another image sensor, such as the 2D camera of his laptop.

According to some embodiments, device 10 need not be used and the projecting device 12 may be connected directly to a processor unit (for example, through a USB connector) for projecting content available on the processor unit.

The image sensor 14 is typically positioned in relation to projecting device 12 such that its line of sight 104 is not the same as the line of sight 102 of the projecting device 12.

Image sensor 14 obtains images of the projection area 15 and communicates these sensor images to processor 16. Once a user hand 11 appears in the projection area 15 image sensor 14 communicates image data of the hand to processor 16. According to one embodiment, processor 16 identifies a hand in the sensor images and directs the projection of symbol 17, which is produced, for example, by device 10 (e.g., by a processor of device 10), onto the identified hand. Processor 16 may determine the location of symbol 17 in each image and based on displacement of the symbol 17 in each image, processor 16 may calculate the distance of the user hand 11, in each image, from a known location, such as from the surface 13.

The functions carried out by processor 16 may be performed by a single processing unit (such as processor 16) or by several processors. According to some embodiments, image sensor 14 and projecting device 12 are positioned in a predetermined, typically fixed, position in relation to each other. According to one embodiment image sensor 14 is an integral or modular part of projecting device 12 (as shown, for example, in FIG. 1A). According to other embodiments image sensor 14 and projecting device 12 are each separately mobile and they are not arranged in a fixed or set position relative to each other.

According to some embodiments, image sensor 14 and/or processor 16 may be an integral or modular part of the device 10 (as shown, for example, in FIG. 1B) or they may be physically separate units in communication (such as wired or wireless communication) with device 10.

Based on the calculated distance of the hand from the surface and the location of the hand within the sensor image, a hand movement may be translated to key pressing, object/icon selecting, drawing, dragging and other man-machine interactions.

Furthermore, based on the calculated distance of the user's hand from the surface it can be determined whether the hand is touching the surface. Once it is determined that the user's hand is touching the surface, the device 10 may be made to respond as it would in response to the user touching a touch screen.

According to one embodiment hand movement along the Z axis (hand 11 getting closer or further away from the projection surface 13) is translated into a specific interaction. Other embodiments enable translation of movement of hand 11 along the X and Y axes. For example, hand movement along the Z axis may be used to emulate a button press or mouse click on a specific (X,Y) location within the projection area 15, and hand movement along the X and/or Y axes may be translated into on-line drawing or illustration upon a presentation. For example, a user may underline or draw a circle around specific text while the text is being projected/displayed so as emphasize that text to the viewers. According to some embodiments, other specific hand gestures (pre-defined hand movements) may be used for on-line user interaction with a presentation.

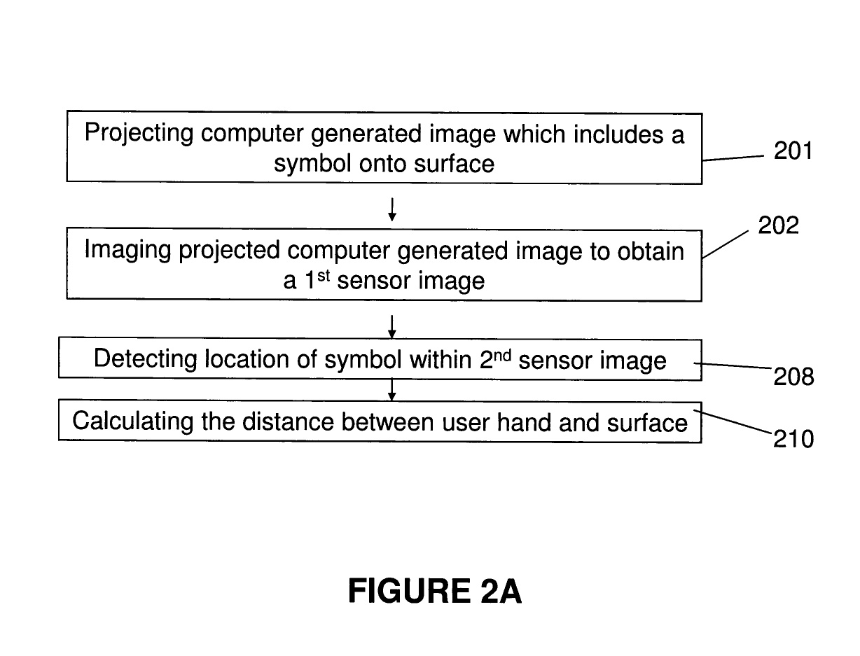

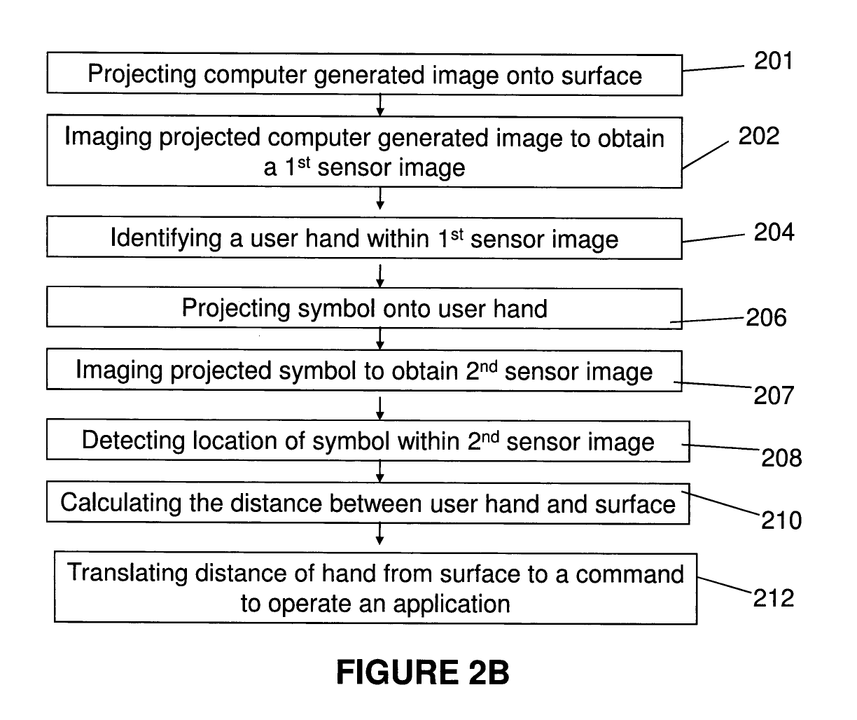

A method of interacting with projected content, according to one embodiment of the invention, is schematically illustrated in FIG. 2A. According to one embodiment the method includes projecting a computer generated image which includes at least one symbol onto a surface (201); imaging the projected computer generated image to obtain a sensor image (202); detecting the location of the graphic symbol within the sensor image (208); and when a user hand is present in the sensor image, calculating the distance between the user hand and the surface based on the location of the graphic symbol in the sensor image (210). As described above, the distance of the user's hand from the surface may be translated to specific commands or operations.

According to another embodiment, which is schematically illustrated in FIG. 2B, the method includes projecting a computer generated image onto a surface (201); imaging the projected computer generated image to obtain a first sensor image (202); identifying a user hand within the first sensor image (204); projecting a graphic symbol onto the user hand (206); imaging the projected graphic symbol to obtain a second sensor image (207); detecting the location of the graphic symbol within the second sensor image (208); and calculating the distance between the user hand and the surface based on the location of the graphic symbol in the second sensor image (210) (examples of these calculations will be discussed below).

When the hand moves there may be a delayed response of the system which may cause the symbol location to be inaccurate. According to some embodiments, in order to avoid inaccurate positioning of the symbol images captured by the imager may be synchronized with the computer generated images after which the location of the symbol may be extrapolated based on movement of the hand and/or on the new location of the hand.

For example, a user's hand may be located at location p1 in frame n1. The system calculates location p1, projects a symbol to location p1 and an image of frame n2 is now obtained which includes the symbol so as to be able to compare between expected (theoretical) and actual location (in frame n2) of the symbol. However, in frame n2 the user's hand may have moved to location p2 so that projecting the symbol to location p1 in frame n2 may cause the symbol to be projected to a wrong location. Thus it may be advantageous to be able to extrapolate the location p2 to be able to project the symbol to location p2 in frame n2.

According to one embodiment each frame contains a grid of set locations and a symbol may be projected only to a location that is defined by the grid. The grid is made such that the distance between grid points is bigger than the maximal (expected) displacement of the symbol. The location of the user's hand in frame n2 is determined relative to the set locations of the grid and the symbol is projected in frame n2 to the set location which is closest to the location of the hand in frame n2.

According to another embodiment a synchronizing pattern or sign is projected by the system simultaneously with projection of the symbol. The synchronizing pattern is different for each frame such that each synchronizing pattern may be correlated to a specific frame. According to some embodiments the synchronizing pattern is a cyclic pattern (for example, a different pattern or sign shown for each of 100 different frames and then again for the next 100 frames). For example, the synchronizing pattern may be a toothed wheel which turns at the rate of one tooth per frame. The position of the teeth of the toothed wheel in each frame indicates the number of that specific frame. Thus, it can be known that in frame n1 a user's hand was in location p1 and in frame n2 in location p2 etc. Based on this information of movement of the user's hand an extrapolation of p(x) may be made for frame n(x) and the symbol may be projected to location p(x) without having to determine the actual location of the hand in frame n(x).

According to some embodiments, the distance of the hand from the surface is translated by, for example, a computer processor to a command to operate an application (212), for example, on the computer. According to some embodiments the distance of the hand from the surface can be translated into a touch or non-touch event. A touch event, which may be identified if the user hand is determined to be at a very close distance from the surface (for example, under a pre-determined distance from the surface), typically triggers an operation usually associated with a mouse click or double click on an icon or touch on a touch screen (e.g., selecting and/or opening files, documents etc.). Additionally, a touch event may include tracking of the hand and identifying a specific movement or gesture, which may be used to trigger adding graphics to the presentation, such as drawing a line on the presentation or pointing to the presentation.

According to some embodiments positioning a user hand without movement in a specific position, for a predetermined period of time, may be translated by the system as a “right click”.

It should be appreciated that the on screen location of the user hand can be used both for being able to project the graphic symbol onto the hand and for determining where, within the context of the projected content, a hand movement has been preformed.

Calculated or determined distance need not be the absolute or exact distance. Relative or approximated distances may be used according to embodiments of the invention.

According to one embodiment, in order to establish the on-screen location of the hand and/or the required location of the symbol so that it is projected onto the hand, the sensor image needs to be aligned with the computer generated image.

According to one embodiment alignment of the sensor image with the computer generated image includes geometrical transformation in which X,Y coordinates of the sensor image are transformed or converted to the computer generated image X,Y coordinates.

According to one embodiment the conversion may use image corners as known in camera calibration techniques.

According to one embodiment, the relative position of the image sensor and the projecting device is fixed such that the conversion of coordinates may be a fixed conversion. According to other embodiments the relative position of the image sensor and the projecting device varies such that machine learning techniques may need to be applied for the conversion. For example, bi-linear transform methods may be applied.

According to another embodiment several computer generated symbols or points at known coordinates may be projected onto the projection surface prior to use. The projection surface is then imaged to obtain a calibration sensor image. The relative position of the points in the calibration sensor image is compared to the known coordinates of the projected points, to obtain the conversion parameters. This method may be used advantageously when the distance of the image sensor to the projecting device is not a fixed distance, or alternatively a fixed but unknown distance.

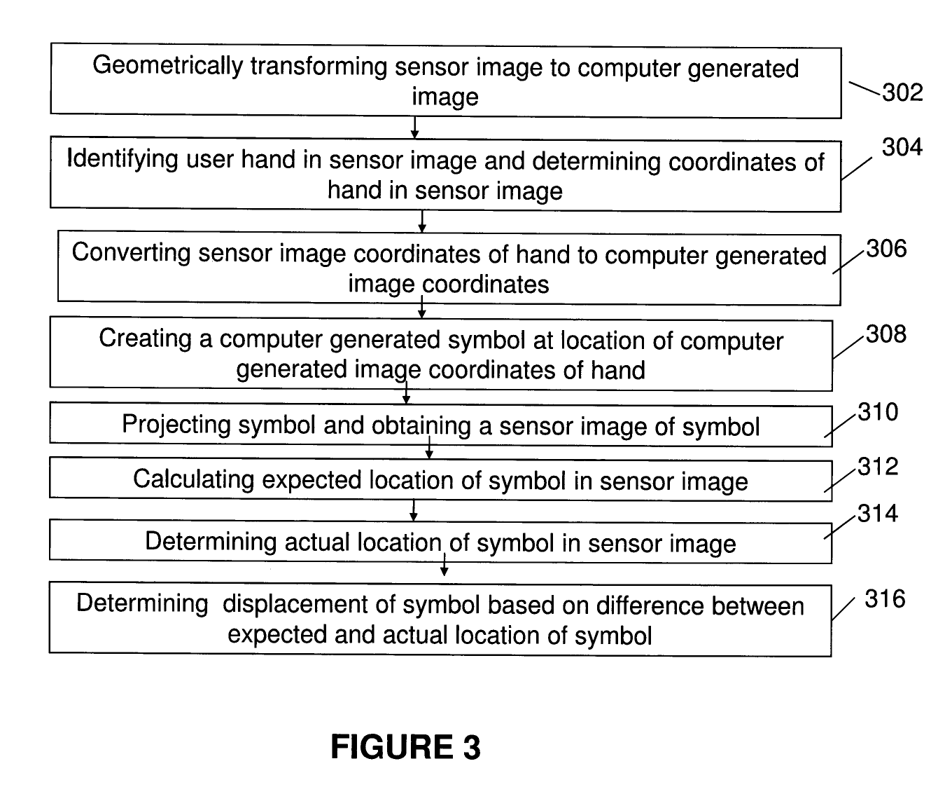

An exemplary method for calculating the distance of a user hand from a projection surface is schematically described with reference to FIG. 3.

In a first step the sensor image is geometrically transformed to the computer generated image (302) such that each coordinate of the sensor image can be translated to a coordinate of a computer generated image. In a second step a user hand shape is identified in the sensor image and the sensor image coordinates of the hand shape are determined (304). The sensor image coordinates of the hand shape are now converted to computer generated image coordinates (306) (e.g., based on the transformation of step 302). A computer generated symbol is now created at the location of the computer generated image coordinates of the hand (308). The computer generated symbol is projected onto a surface (since the symbol is created at the coordinates of the hand, the symbol is actually projected onto a user's hand that is positioned on or near the surface) and a sensor image of the symbol is obtained (310). An expected (theoretical) location of the symbol in the sensor image is calculated (312) (e.g., based upon the transformation of step 302). The actual location of the symbol in the sensor image is determined (314) and the expected location of the symbol (from step 312) is compared to the actual location (calculated in step 314) to see if there is a difference between the locations. The difference between the expected location and actual location is the symbol displacement. Thus, the displacement of symbol is determined based on the difference between expected and actual location of the symbol (316).

According to some embodiments, the user hand may be tracked, for example by identifying pixels (within the initially identified hand shape) having similar movement and location parameters and tracking those pixels rather than identifying a hand in each image frame.

According to one embodiment the symbol is a ring shaped icon and the center of a ring shaped symbol is located (and tracked), for example, by applying mean least square calculations for an equation of a circle.

Identifying a user hand within the sensor image (see step 304) can be done by image analysis techniques such as by the use of shape recognition and motion detection algorithms.

Shape recognition methods may include edge detection algorithms. For example, the analysis may include identifying a combination of edge data that is unique to a hand, e.g., a group of parallel edges, edges spaced apart by a minimal space (width of finger), typical angles between fingers, etc. Selected features may be compared to a model of a hand and a user hand may be identified based on the proximity of these features to the model.

According to one embodiment, motion detected throughout a number of frames may indicate the appearance of a hand thus triggering algorithms for identifying and tracking a hand. For example, selecting a set of pixels distributed in a first frame; tracking the movement of the pixels from the first frame to a second frame; selecting a group of pixels that have substantially similar movement properties; matching a shape of a hand that best overlaps the group of pixels; and identifying the user hand based on the matching. The group of pixels may be integrated over a plurality of frames prior to the step of matching.

Sometimes, however, lighting conditions and/or the nature of projected content may render shape detection alone a less than desirable method for identifying a hand in an image.

According to one embodiment the system (e.g., the system illustrated in FIG. 1) may include an additional light source, such as an IR light source, to assist hand identification in difficult lighting or background conditions.

According to additional embodiments, calibration and machine learning techniques may be applied to enhance hand shape identification.

According to one embodiment both color transformation and geometric transformation may be used in detecting a hand or any other external object in the sensor image.

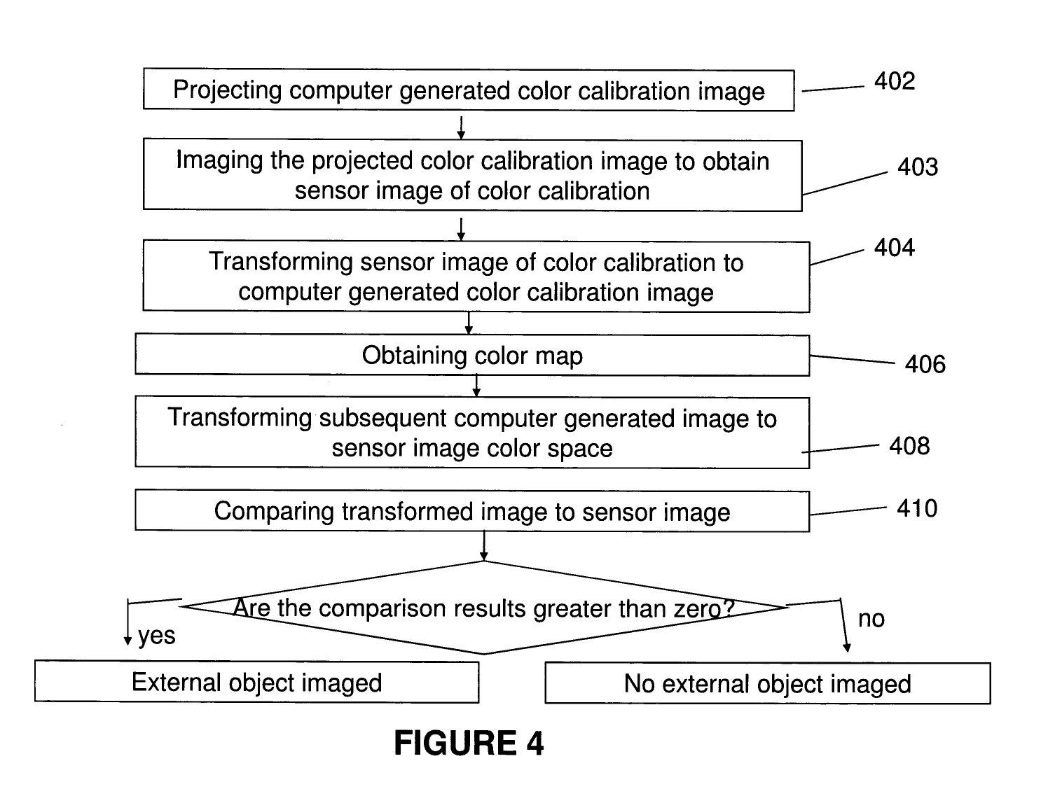

For example, according to one embodiment which is schematically illustrated in FIG. 4, as an initial step, a color calibration image (such as a color grid) is generated (for example by device 10) and projected onto a surface (402). The projected image is imaged (for example, by image sensor 12) to obtain a sensor image of the calibration image (403). Geometric transformation of a sensor image of the calibration image to the computer generated image of the calibration image, is preformed (404). Next, a color map is obtained (406) in which each color in the computer generated image of the calibration image is mapped to its corresponding color in the sensor image of the calibration image.

Once in operational use, subsequent computer generated images are transformed to the sensor image geometrical and color space (408). The transformed image is then compared to the sensor image (410) for example, by subtracting the two images. Subtraction of the transformed image from the sensor image is expected to be zero in cases where no external object (such as a user's hand) is introduced into the sensor image. When subtraction of a sensor image from a transformed image is different than zero, this can indicate the presence of an external object, such as a user hand, within the sensor image. Thus a user's hand may be detected even without detecting a hand shape. However, according to some embodiments shape recognition algorithms, such as edge or contour detection may be applied to the comparison data (such as the subtraction image) to further enhance hand detection based on shape parameters.

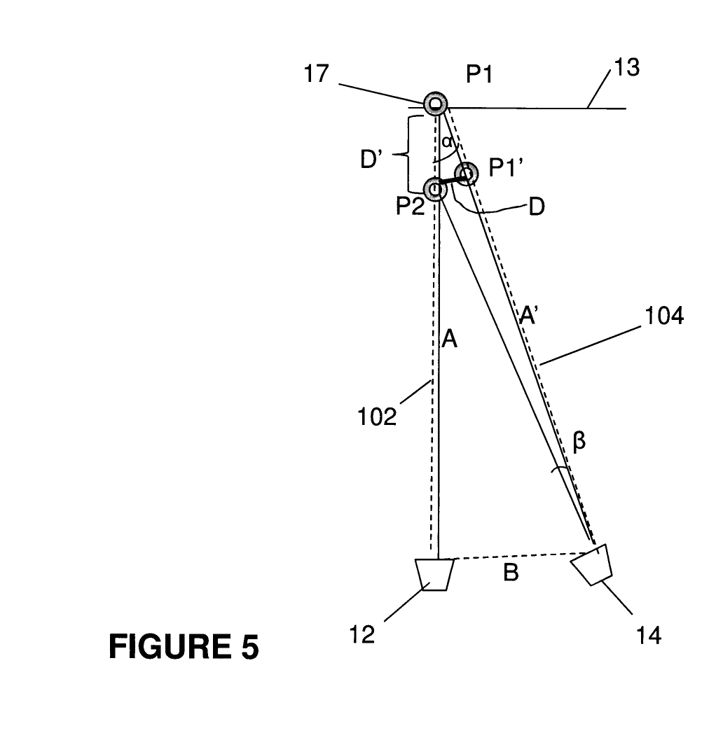

As discussed above, displacement of the symbol may be translated into distance of the user's hand from the projection surface. An exemplary method of translating displacement into distance of a user hand from a surface is described with reference to FIG. 5.

A projecting device 12 may be set up by the user at a known (or estimated) distance from the projection surface 13 (estimation may be done for example by assuming the user has an average size hand, and by comparing the hand size detected in the sensor image to this average size). An image sensor 14 may be fixed or set at a predetermined, known (or estimated) distance from the projecting device 12. The distance between the projecting device 12 and image sensor 14, (B), may be for example 60 mm. The distance from the projecting device 12 to the projection surface 13 (A) may be for example 1000 mm. Thus, assuming a right angle between the projecting device 12 line of sight 102 and the image sensor 14 the angle α can be calculated, (e.g., tan α=B/A).

Symbol 17 is located in a first position (P1) within the image sensor 14 field of view, when projected directly onto the projection surface 13, for example, when projected in a calibrating step, without a user hand being present. When the symbol is projected onto a user hand it is located at another position (P2) within the image sensor 14 field of view. Thus, the symbol has been displaced by angle β. Angle β can be calculated using the displacement in pixels between P1 and P2 and the known image sensor parameters—imager angle of view and number of pixels of the sensor (usually provided by the manufacturer).

The distance between P2 and the line of site 104 of the image sensor is marked by line D (which creates a right angle with A′ at point P1′). Assuming A˜A′, the distance D can be calculated (e.g., D=tan β*A). Once D is known it can be used, together with angle α, to give a good approximation of the distance D′ (e.g., D′=D/tan α), which is the distance of the user's hand from the projection surface.

1-10. (canceled)

11. A method for user interaction with projected content, the method comprising
projecting a computer generated image onto a surface, said computer generated image comprising at least one symbol;
imaging the projected computer generated image to obtain a sensor image;
detecting the location of the symbol within the sensor image; and
based on the location of the symbol in the sensor image, controlling a device.

12. The method according to claim 11 comprising projecting the computer generated image onto a user's hand and calculating a distance of the user's hand from the surface based on the location of the symbol in the sensor image.

13. The method according to claim 11 comprising transforming coordinates of the sensor image to coordinates of the computer generated image.

14. The method according to claim 12 comprising detecting a location of the user's hand within the sensor image.

15. The method according to claim 14 comprising determining if the distance of the user's hand from the surface is below a pre-determined distance and if the distance of the user's hand from the surface is below a pre-determined distance, simulating a touch event on the computer generated image at the location of the hand.

16. The method according to claim 12 wherein calculating a distance of the user's hand from the surface comprises:
calculating an expected location of the symbol in the sensor image;
detecting an actual location of the symbol in the sensor image; and
comparing the expected location to the actual location.

17. The method according to claim 11 comprising:
identifying a hand in the sensor image;
identifying the hand location within the sensor image;
translating the hand location within the sensor image to a hand location within the computer generated image; and
generating the computer generated image comprising at least one symbol located at the hand location within the computer generated image.

18. The method according to claim 17 comprising extrapolating the location of the symbol within the computer generated image.

19. The method according to claim 17 wherein the computer generated image comprises a synchronization pattern.

20. A method for detecting an external object on projected computer generated content, the method comprising:
creating a color transformation function between a projected computer generated image and a sensor image of the projected computer generated image;
transforming coordinates of the projected computer generated image to coordinates of the sensor image;
transforming color space of the projected computer generated image to the color space of the sensor image, thereby obtaining a transformed image;
comparing the transformed image to the sensor image; and
determining if an external object is detected in the sensor image based on the comparison.

21. The method according to claim 20 comprising:
projecting a color calibration computer generated image;
imaging the projected color calibration image thereby obtaining a calibration sensor image;
creating a color map based on the calibration sensor image and computer generated image; and
using the color map as the color transformation function.

22. The method according to claim 20 wherein transforming coordinates of the computer generated image to coordinates of the sensor image comprises transforming corners of the computer generated image to corners of coordinates of the sensor image.

23. The method according to claim 20 wherein the external object is a user's hand.

24. The method according to claim 11 wherein detecting the location of the symbol within the sensor image comprises:
creating a color transformation function between the projected computer generated image and the sensor image;
transforming coordinates of the projected computer generated image to coordinates of the sensor image;
transforming color space of the projected computer generated image to the color space of the sensor image, thereby obtaining a transformed image;
comparing the transformed image to the sensor image; and
determining the location of the symbol within the sensor image based on the comparison.

25. The method according to claim 24 comprising:
projecting a color calibration computer generated image;
imaging the projected color calibration image thereby obtaining a calibration sensor image;
creating a color map based on the calibration sensor image and computer generated image; and
using the color map as the color transformation function.

26. The method according to claim 24 wherein transforming coordinates of the computer generated image to coordinates of the sensor image comprises transforming corners of the computer generated image to corners of coordinates of the sensor image.

27. The method according to claim 20 comprising:
determining a location of the external object in the sensor image; and
controlling a device based on the location of the external object.
